(19) United States
(12) Patent Application Publication
(10) Pub. No.: US 2026/0230186 A1
(43) Pub. Date: Aug. 6, 2026

(54) DYNAMIC DUTY CYCLE CONTROL FOR AN ESTIMATOR

(71) Applicants: Idea Sistemas Eletronicôs LTDA S.A., Campinas (BR); Universidade Estadual de Campinas, Campinas (BR)

(72) Inventors: Lucas DE CAMARGO BARROS DE CASTRO, Valinhos (BR); Jonathas EVANGELISTA DA SILVEIRA, Paulínia (BR); Daniel LAZARI, Ribeirão Preto (BR); Rodrigo Pascoal ZELI, São José dos Campos (BR); Rodolfo Jardim AZEVEDO, Valinhos (BR); Lucas Francisco WANNER, Paulínia (BR); Marcelo Guedes SILVA, Campinas (BR); Victor TOON DE ARAÚJO, Campinas (BR)

(21) Appl. No.: 19/149,688

(22) PCT Filed: Feb. 16, 2024
(86) PCT No.: PCT/IB2024/051477

§ 371 Date: Jul. 21, 2025

Related U.S. Application Data
(60) Provisional application No. 63/485,387, filed on Feb. 16, 2023.

(51) Int. Cl. H04B 10/40; H04B 10/079; H04B 10/564; H04B 10/61

(52) U.S. Cl. CPC H04B 10/40; H04B 10/0795; H04B 10/564; H04B 10/61

(57) ABSTRACT

In some implementations, a controller of a digital coherent optics (DCO) transceiver may schedule execution of an estimator of a digital signal processor (DSP) of the DCO transceiver based on a sleep period, where each execution of the estimator causes the estimator to compute a physical environment estimation using a signal being processed at the DSP, and where the physical environment estimation is to be used by a corrector of the DSP to perform corrections of physical impairments of the signal. The con-2024/171126 troller may obtain, from the estimator, feedback data relating to an execution of the estimator. The controller may perform a comparison of the feedback data and reference data. The controller may adjust, based on the comparison of the feedback data and the reference data, the sleep period to schedule execution of the estimator.

### CROSS-REFERENCE TO RELATED APPLICATION

This Patent Application claims priority to U.S. Provisional Patent Application No. 63/485,387, filed on Feb. 16, 2023, and entitled “DYNAMIC DUTY CYCLE CONTROL FOR A COHERENT DIGITAL SIGNAL PROCESSOR (DSP) APPLICATION SPECIFIC INTEGRATED CIRCUIT (ASIC).” The disclosure of the prior Application is considered part of and is incorporated by reference into this Patent Application.

### TECHNICAL FIELD

The present disclosure relates generally to optical transceivers and to dynamic duty cycle control for an estimator of an optical transceiver.

### BACKGROUND

An optical module (e.g., an optical transceiver) capable of achieving high-speed data communication may be used in a data center, a node of an optical network, or the like. An optical transceiver may include, as main components, a light emitting function portion (transmitter optical subassembly (TOSA)) that converts electrical signals into optical signals and a light receiving function portion (receiver optical subassembly (ROSA)) that, in turn, converts optical signals into electrical signals for high-speed data communication in an optical network, such as a fiber optic network.

### SUMMARY

In some implementations, a digital coherent optics (DCO) transceiver includes an optical receiver including reception optics configured to receive an optical reception signal, and a demodulator configured to recover an electrical reception signal from the optical reception signal using a local oscillator signal. The DCO transceiver may include an optical transmitter including a modulator configured to produce an optical transmission signal by modulating an optical carrier signal from a laser source with an electrical transmission signal, and transmission optics configured to transmit the optical transmission signal. The DCO transceiver may include a digital signal processor (DSP) that includes an estimator configured to compute physical environment estimations using a digital signal that is based on the electrical reception signal or the electrical transmission signal, and a corrector configured to perform corrections of physical impairments of the digital signal based on the physical environment estimations. The DCO transceiver may include a controller configured to schedule execution of the estimator based on a sleep period, where each execution of the estimator causes the estimator to compute a physical environment estimation using the digital signal. The controller may be configured to obtain, from the estimator, feedback data relating to the physical environment estimation. The controller may be configured to adjust, based on the feedback data, the sleep period to schedule execution of the estimator.

In some implementations, a method includes scheduling, by a controller of a DCO transceiver, execution of an estimator of a DSP of the DCO transceiver based on a sleep period, where each execution of the estimator causes the estimator to compute a physical environment estimation using a signal being processed at the DSP, and where the physical environment estimation is to be used by a corrector of the DSP to perform corrections of physical impairments of the signal. The method may include obtaining, by the controller and from the estimator, feedback data relating to an execution of the estimator. The method may include performing, by the controller, a comparison of the feedback data and reference data. The method may include adjusting, by the controller and based on the comparison of the feedback data and the reference data, the sleep period to schedule execution of the estimator.

In some implementations, a DCO transceiver includes a DSP that includes an estimator configured to compute physical environment estimations using a signal at the DSP, and a corrector configured to perform corrections of physical impairments of the signal based on the physical environment estimations. The DCO transceiver may include a controller configured to schedule execution of the estimator based on a sleep period, where each execution of the estimator causes the estimator to compute a physical environment estimation using the signal. The controller may be configured to obtain, from the estimator, feedback data relating to an execution of the estimator. The controller may be configured to adjust, based on the feedback data, the sleep period to schedule execution of the estimator.

### BRIEF DESCRIPTION OF THE DRAWINGS

FIG. 1 is a diagram illustrating an example DCO transceiver.

FIG. 2 is a diagram illustrating an example associated with dynamic duty cycle control for an estimator.

FIG. 3 is a flowchart of an example process associated with dynamic duty cycle control for an estimator.

### DETAILED DESCRIPTION

The following detailed description of example implementations refers to the accompanying drawings. The same reference numbers in different drawings may identify the same or similar elements.

Optical networks, such as fiber optic networks, facilitate transmission of large amounts of information over great distances. An optical network may utilize coherent optics, which enables more efficient use of optical fiber transmission capacity. In coherent optics, a signal may be modulated both in amplitude and phase of light, while also utilizing transmission in two polarizations, to thereby increase an amount of information that can be transmitted in the optical network. Due to this complex modulation scheme, as well as due to physical impairments that are present in long runs of optical fiber, preparing data for transmission and recovering transmitted data may be challenging in coherent optics.

An optical network may employ digital coherent optics (DCO) transceivers for transmitting and receiving data using coherent optics. A DCO transceiver may include an optical receiver to receive an optical signal and recover an electrical signal from the optical signal, an optical transmitter to modulate an optical signal with an electrical signal and transmit the optical signal, and a digital signal processor (DSP) to process the electrical signals. The DSP (e.g., an application-specific integrated circuit (ASIC) configured for digital signal processing) may include components (e.g., signal processing circuitry), known as correctors and estimators, for preparing a signal that is to be transmitted and/or for recovering information from a received signal. A corrector may include circuitry in a datapath of the DSP that is configured to correct a physical impairment affecting a signal. An estimator may include circuitry configured to periodically obtain a signal in the datapath and to compute estimations based on the signal, which are used by one or more correctors for signal correction. As one example, a carrier frequency offset estimator (CFE) may be configured to estimate a carrier frequency offset, representing a difference of frequencies of a transmitter light source and a local oscillator, in a received signal.

Operations of the correctors are time critical, and the correctors should operate at peak capacity to achieve high data rates in the optical network. On the other hand, operations of the estimators may be performed periodically. For example, an estimator may perform a computation and then remain idle for a time period, thereby defining a duty cycle of the estimator. Generally, the duty cycle of the estimator may be fixed. Moreover, the estimator may run at a frequency determined by worst-case conditions to ensure that the DCO transceiver remains within a particular range of operable limits, even in extreme scenarios. This approach minimizes inactive periods of the estimator to provide estimations for signal correction and recovery in worst-case conditions. However, operation of the estimator according to this fixed duty cycle may consume significant power, despite the worst-case conditions occurring seldomly. For example, even in favorable conditions in which the estimator is needed infrequently, the estimator may operate at a high frequency intended for worst-case scenarios, unnecessarily consuming power.

Some implementations described herein enable control of a dynamic duty cycle for an estimator of a DSP of a DCO transceiver. In some implementations, the DCO transceiver may include a scheduling controller for the estimator. The scheduling controller may include a control algorithm implemented in firmware, a field-programmable gate array (FPGA), an ASIC, or as instructions in a memory of the DCO transceiver. The scheduling controller may schedule execution of the estimator based on a sleep period. For example, in accordance with a scheduled execution of the estimator, the scheduling controller may provide a control signal to the estimator that causes the estimator to turn on or enter an active mode.

Execution of the estimator may cause the estimator to compute a physical environment estimation using a signal at the DSP (e.g., a digital signal). The estimator may provide the physical environment estimation to a corrector, and the corrector may perform a correction of physical impairments of the signal based on the physical environment estimation, to thereby improve the signal for transmission or recover the signal that is received. Moreover, the scheduling controller may obtain, from the estimator, feedback data relating to the execution of the estimator. In some implementations, the feedback data may indicate the physical environment estimation (e.g., the feedback data provided by the estimator to the scheduling controller may be the same as data provided by the estimator to the corrector). Additionally, or alternatively, the feedback data may indicate a temperature at the DSP and/or a bit error rate (BER) at the DSP, among other examples. After providing the feedback data to the scheduling controller, the estimator may turn off or enter a sleep mode (e.g., the estimator may transition to a state where it does not perform computations or compute physical environment estimations, and/or where it does not consumer power, or its power consumption is very low or minimal).

The scheduling controller may perform a comparison of the feedback data and reference data. The reference data may include previous feedback data relating to a previous execution (e.g., an immediately preceding execution) of the estimator. Additionally, or alternatively, the reference data may include a threshold value, a target value, an error value, and/or a setpoint, among other examples. In some implementations, to perform the comparison of the feedback data and the reference data, the scheduling controller may determine a difference between the feedback data and the reference data.

The scheduling controller may adjust the sleep period (i.e., adjust a duration of the sleep period, or adjust a time that the estimator is off or in sleep mode) to schedule execution of the estimator based on the comparison of the feedback data and the reference data. During the sleep period, the estimator is not to compute physical environment estimations. Accordingly, by adjusting the sleep period, the scheduling controller can manipulate a frequency at which the estimator executes. In other words, adjusting the sleep period may increase or decrease a duration of a sleep mode of the estimator, thereby providing dynamic duty cycle control for the estimator.

To adjust the sleep period, the scheduling controller may increase the sleep period based on the comparison of the feedback data and the reference data indicating an improvement of a quality of the signal (so that the estimator performs computations less frequently and conserves power in good signal quality conditions). For example, if the difference between the feedback data and the reference data is getting smaller relative to comparisons involving previous feedback data, then the scheduling controller may increase the sleep period. Alternatively, to adjust the sleep period, the scheduling controller may decrease the sleep period based on the comparison of the feedback data and the reference data indicating a deterioration of a quality of the signal (so that the estimator performs computations more frequently to facilitate signal correction and recovery in bad signal quality conditions). For example, if the difference between the feedback data and the reference data is getting larger relative to comparisons involving previous feedback data, then the scheduling controller may decrease the sleep period.

In this way, the scheduling controller may schedule execution of the estimator in accordance with the adjusted sleep period. For example, the scheduling controller may wait for the sleep period before causing a subsequent execution of the estimator. Moreover, the scheduling controller may obtain feedback data from the estimator relating to the subsequent execution, which the scheduling controller may use for further adjustment of the sleep period, and so forth each time the estimator executes. Accordingly, the scheduling controller provides dynamic duty cycle control for the estimator. In this way, the scheduling controller may reduce power consumption by the estimator while ensuring frequent-enough execution of the estimator to facilitate signal correction and recovery by the corrector.

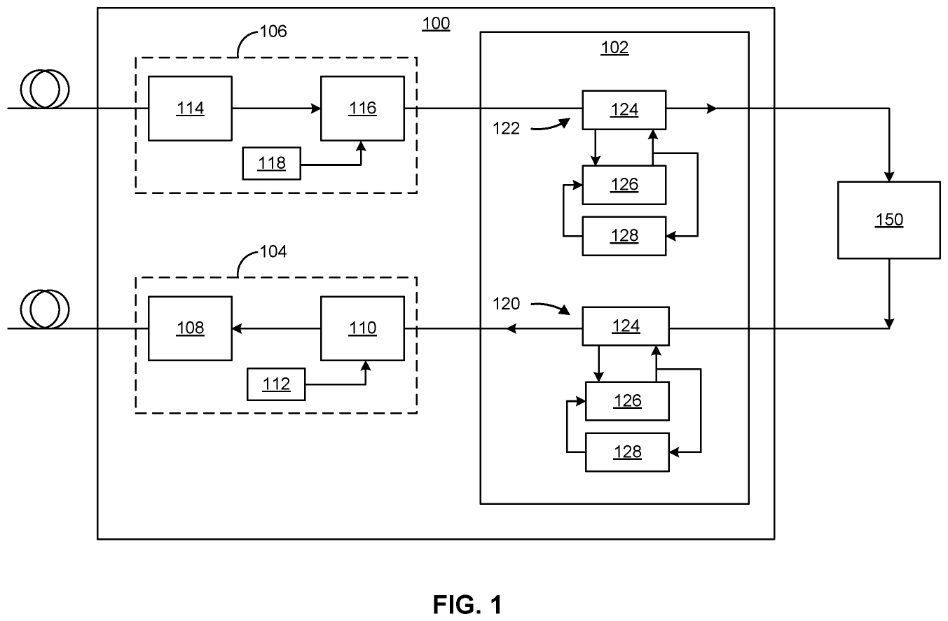

FIG. 1 is a diagram illustrating an example DCO transceiver 100. The DCO transceiver 100 may be configured to perform transmission and reception of optical signals. The DCO transceiver 100 may communicate with a host system 150 (e.g., a router, a switch, or the like), which may be associated with a data center or a node of an optical network. As shown, the DCO transceiver 100 may include a DSP 102 (e.g., a DSP ASIC), an optical transmitter 104, and an optical receiver 106.

Furthermore, the optical transmitter 104 may include transmission optics 108, a modulator 110, and a laser source 112, and the optical receiver 106 may include reception optics 114, a demodulator 116, and a local oscillator 118. The laser source 112 and the local oscillator 118 may be different components, as shown, or may be the same component.

The DSP 102 may be configured to process a digital signal in a transmission datapath 120 or in a reception datapath 122. A datapath 120 or 122 may include a series of correctors 124 (e.g., corrector algorithms implemented in circuitry). The DSP 102 may include estimators 126 (e.g., estimator algorithms implemented in circuitry) associated with the transmission datapath 120 and/or the reception datapath 122. The estimators 126 may be configured to compute physical environment estimations relating to the digital signal. For example, the physical environment estimations may relate to carrier frequency, carrier phase, clock phase, DC offset, in-phase and quadrature (IQ) imbalance, or optical fiber impairments (e.g., non-linear effects). An estimator 126 may be configured to compute physical environment estimations based on the digital signal in a datapath 120 or 122 and to provide the physical environment estimations to a corrector 124. An estimator 126 may be configured to compute physical environment estimations based on information from or about the components of the optical transceiver 100, such as those components described herein, and/or thermistors, thermoelectric coolers (TECs), electrical signals provided to or within the DCO transceiver 100 and other components. The corrector 124 may be configured to perform corrections (e.g., compensations) of physical impairments (e.g., imperfections) of the digital signal based on the physical environment estimations. For example, the corrector 124 may receive an output of the estimator 126, apply a tuning to the corrector 124 based on the output, and process the digital signal based on the tuning that is applied (e.g., process the digital signal with the tuned corrector 124). The physical impairments may be caused by imperfections in optical fiber and/or in the DCO transceiver 100 or any other non-idealities.

In connection with transmission, the DSP 102 may receive a digital signal (e.g., a bytestream) from the host system 150, and the DSP 102 may process the digital signal in the transmission datapath 120, as described above. The DSP 102 may output an electrical transmission signal (e.g., via a digital to analog converter (DAC)) to the modulator 110. The modulator 110 may be configured to produce an optical transmission signal by modulating an optical carrier signal from the laser source 112 with the electrical transmission signal. The modulator 110 may include an IQ modulator, such as a dual polarization (DP) and IQ modulator. For example, the signal input to the modulator 110 may be split into two orthogonal polarizations, an x-polarization (or horizontal polarization) and a y-polarization (or vertical polarization), and each polarization may be modulated with I and Q inputs (e.g., quadrature phase shift keying (QPSK) modulation) before being combined at an output of the modulator 110. In some implementations, the modulated signal output by the modulator 110 may be a DP-QPSK signal. The modulator 110 may output the modulated signal to the transmission optics 108. The transmission optics 108 may be configured to transmit the optical transmission signal from the DCO transceiver 100 (e.g., via optical fiber).

In connection with reception, the reception optics 114 may be configured to receive an optical reception signal arriving at the DCO transceiver 100 (e.g., via optical fiber). In some implementations, the optical reception signal may be a DP-QPSK signal. The demodulator 116 may be configured to recover an electrical reception signal from the optical reception signal using a local oscillator signal of the local oscillator 118. The demodulator 116 may include an optical hybrid mixer (e.g., 90 degree optical hybrid mixer). For example, the optical reception signal may be split into the two polarizations, and each polarization may be demodulated by mixing with the local oscillator signal to obtain I and Q outputs. The DSP 102 may receive the electrical reception signal (e.g., via an analog to digital converter (ADC)) from the demodulator 116. The DSP 102 may process the electrical reception signal in the reception datapath 122, as described above. The DSP 102 may provide a digital signal (e.g., a bytestream) from the reception datapath 122 to the host system 150.

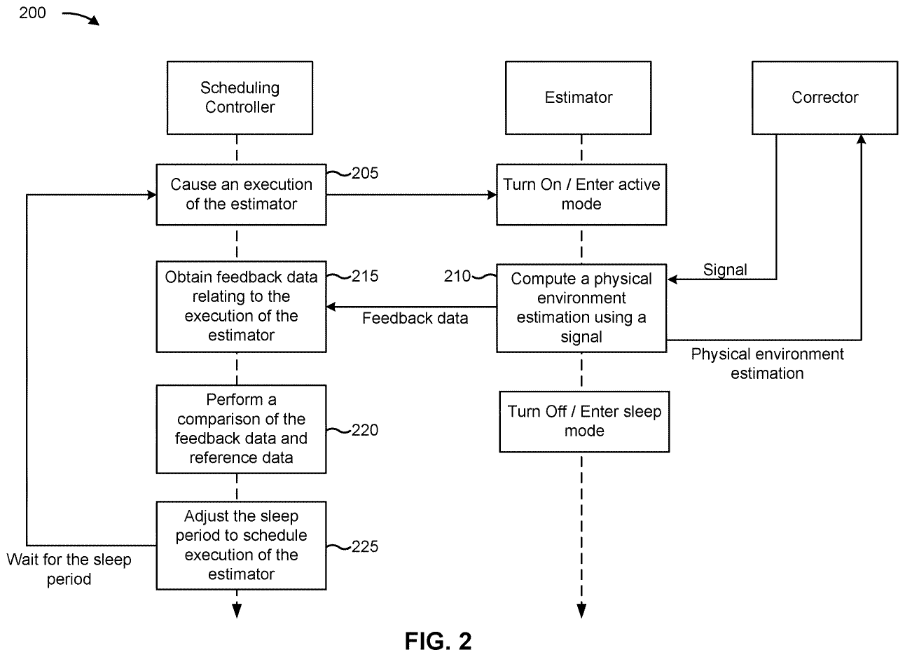

As shown, the DCO transceiver 100 may include one or more scheduling controllers 128. The scheduling controller(s) 128 may provide dynamic duty cycle control of the estimators 126, as described further in connection with FIG. 2. In some implementations, an estimator 126 may include periodic-execution hardware (e.g., circuitry that executes on a recurring basis, but not necessarily at regular intervals) that has a capability of executing according to a fixed duty cycle or according to a dynamic duty cycle using the scheduling controller(s) 128. In other words, a configuration of the periodic-execution hardware, capable of executing according to a dynamic duty cycle, may be unmodified from a fixed-duty-cycle configuration for the periodic-execution hardware.

The scheduling controller(s) 128 may be communicatively coupled (e.g., by wired connections) with the estimators 126. For example, the scheduling controller(s) 128 may receive data from the estimators 126 and provide data to the estimators 126. In some implementations, the DCO transceiver 100 may include a first scheduling controller 128 for estimators 126 associated with the transmission datapath 120 and a second scheduling controller 128 for the estimators 126 associated with the reception datapath 122. In some implementations, the DCO transceiver 100 may include only a single scheduling controller 128 for the estimators 126 associated with the transmission datapath 120 and the reception datapath 122.

A scheduling controller 128 may be implemented in the DSP 102 or in the DCO transceiver 100 outside of the DSP 102. In some implementations, the scheduling controller 128 may include hardware (e.g., of the DSP 102). For example, the scheduling controller 128 may be implemented in an FPGA, an ASIC, or other dedicated circuitry of the DSP 102. In some implementations, the scheduling controller 128 may include one or more memories and one or more processors of the DCO transceiver 100 (e.g., of the DSP 102), communicatively coupled to the one or more memories, configured to perform control operations of the scheduling controller 128. For example, control operations of the scheduling controller 128 may be implemented as firmware or other software, or otherwise as instructions, in the one or more memories.

As indicated above, FIG. 1 is provided as an example. Other examples may differ from what is described with regard to FIG. 1.

FIG. 2 is a diagram illustrating an example 200 associated with dynamic duty cycle control for an estimator. As shown in FIG. 2, example 200 includes a scheduling controller, an estimator (which may also be referred to as an “estimator unit” or an “estimator component”), and a corrector (which may also be referred to as a “corrector unit” or a “corrector component”). The estimator and the corrector may be included in a DSP (e.g., DSP 102) of a DCO transceiver (e.g., DCO transceiver 100), as described in connection with FIG. 1. The scheduling controller may be included in the DCO transceiver within, or outside of, the DSP. The scheduling controller may correspond to a scheduling controller 128, as described in connection with FIG. 1. The estimator may correspond to an estimator 126 associated with the transmission datapath 120 or the reception datapath 122, as described in connection with FIG. 1. The corrector may correspond to a corrector 124 of the transmission datapath 120 or the reception datapath 122.

The estimator may be a CFE, a carrier phase offset estimator (e.g., configured to estimate a carrier phase offset, representing a phase difference of a transmitter's laser source and a receiver's local oscillator, in a received signal), a clock phase error estimator (e.g., configured to estimate a clock phase error of a clock of the DSP), a DC offset estimator (e.g., configured to estimate a displacement from zero of a mean amplitude of a signal), an IQ imbalance coefficients estimator (e.g., configured to estimate coefficients characterizing an IQ imbalance associated with the DCO transceiver), a non-linearity estimator (e.g., configured to estimate non-linear effects caused by optical fiber impairments), or another duty-cycle-based estimator algorithm. In some implementations, the estimator may be a chromatic dispersion estimator or an inter-symbol interference estimator. In some implementations, techniques described herein may be used for periodic-execution hardware (e.g., duty-cycle-based algorithms) other than estimators.

The scheduling controller may schedule execution of the estimator based on a sleep period. For example, consecutive executions of the estimator may be separated in time by the sleep period. Each execution of the estimator may cause the estimator to compute a physical environment estimation using a signal being processed at the DSP. For example, the signal may be a digital signal (e.g., an electrical signal) in the transmission datapath 120 or the reception datapath 122. In some implementations, the scheduling controller may control execution of the estimator using a control signal.

As shown by reference number 205, the scheduling controller may cause an execution of the estimator (e.g., following a sleep period). To cause the execution of the estimator, the scheduling controller may provide the control signal to the estimator (e.g., to energize a circuit associated with the estimator). In some implementations, the control signal may cause closing of a switch associated with the estimator (e.g., a switch that controls current flowing to the estimator), to thereby cause the estimator to execute. Accordingly, the control signal may cause the estimator to turn on or enter an active mode.

As shown by reference number 210, execution of the estimator may cause the estimator to compute a physical environment estimation using a signal at the DSP (e.g., a digital signal). For example, the estimator may obtain the signal (e.g., from a datapath of the DSP, such as the transmission datapath 120 or the reception datapath 122), and the estimator may compute the physical environment estimation using the signal. The estimator may provide the physical environment estimation (e.g., an electrical signal indicative of the physical environment estimation) to the corrector. The corrector, in turn, may perform a correction of physical impairments of the signal based on the physical environment estimation, to thereby improve the signal for transmission or recover the signal that is received.

As shown by reference number 215, the scheduling controller may obtain, from the estimator, feedback data (e.g., an electrical signal indicative of the feedback data) relating to the execution of the estimator. In some implementations, the feedback data may indicate the physical environment estimation (e.g., the feedback data provided by the estimator to the scheduling controller may be the same as data provided by the estimator to the corrector). Additionally, or alternatively, the feedback data may indicate a temperature at the DSP and/or a BER at the DSP, among other examples. In some implementations, the feedback data may indicate a metric (e.g., a weighted sum) based on the physical environment estimation, the temperature, and/or the BER, among other examples.

After providing the feedback data to the scheduling controller, the estimator may not perform any further computations until the scheduling controller provides another control signal to the estimator. For example, the estimator may turn off or enter a sleep mode (e.g., the estimator may transition to a state where it does not perform computations or compute physical environment estimations, and/or where it does not consumer power, or its power consumption is very low or minimal). As an example, between control signals, the switch associated with the estimator may be open.

As shown by reference number 220, the scheduling controller may perform a comparison of the feedback data and reference data. The reference data may include previous feedback data relating to a previous execution (e.g., an immediately preceding execution) of the estimator. Here, the scheduling controller may have stored the previous feedback data in a storage location of the scheduling controller or the DCO transceiver, and the scheduling controller may retrieve the previous feedback data from the storage location to perform the comparison of the feedback data and the reference data. Additionally, or alternatively, the reference data may include a threshold value, a target value, an error value, and/or a setpoint, among other examples (e.g., that may be provisioned to the scheduling controller). In some implementations, to perform the comparison of the feedback data and the reference data, the scheduling controller may determine a difference (e.g., an absolute difference) between the feedback data and the reference data (e.g., the previous feedback data).

Additionally, or alternatively, to perform the comparison of the feedback data and the reference data, the scheduling controller may determine whether the feedback data is greater than or less than the reference data, determine whether the feedback data is within a particular percentage or tolerance to the reference data, or determine a rate of change of the feedback data based on the reference data, among other examples.

As shown by reference number 225, the scheduling controller may adjust the sleep period (i.e., adjust a duration of the sleep period) to schedule execution of the estimator. For example, the scheduling controller may adjust the sleep period based on the comparison of the feedback data and reference data. During the sleep period, the estimator is not to compute physical environment estimations. Accordingly, by adjusting the sleep period, the scheduling controller can manipulate a frequency at which the estimator executes. In other words, adjusting the sleep period may increase or decrease a duration of a sleep mode of the estimator (or adjust a time that the estimator is off or in sleep mode), thereby providing dynamic duty cycle control for the estimator.

To adjust the sleep period, the scheduling controller may increase the sleep period based on the comparison of the feedback data and the reference data indicating an improvement of a quality of the signal (so that the estimator performs computations less frequently and conserves power in good signal quality conditions). For example, if the difference between the feedback data and the reference data is getting smaller relative to comparisons involving previous feedback data, then the scheduling controller may increase the sleep period. Alternatively, to adjust the sleep period, the scheduling controller may decrease the sleep period based on the comparison of the feedback data and the reference data indicating a deterioration of a quality of the signal (so that the estimator performs computations more frequently to facilitate signal correction and recovery in bad signal quality conditions). For example, if the difference between the feedback data and the reference data is getting larger relative to comparisons involving previous feedback data, then the scheduling controller may decrease the sleep period.

As an example, changes of a physical environment estimation over time may indicate whether a quality of the signal is improving or deteriorating. As another example, changes of a temperature at the DSP over time may indicate a corresponding environmental change that may affect the signal. Increases in BER at the DSP over time may indicate that a quality of the signal is deteriorating, and decreases in BER over time may indicate that the quality of the signal is improving.

In some implementations, the scheduling controller may adjust the sleep period using a linear, step-based control approach. For example, the scheduling controller may adjust the sleep period by a step amount based on the difference between the feedback data and the reference data (e.g., the previous feedback data). The scheduling controller may increase the sleep period by the step amount responsive to the difference between the feedback data and the reference data being less than a first threshold. The scheduling controller may decrease the sleep period by the step amount responsive to the difference between the feedback data and the reference data being greater than a second threshold (e.g., the second threshold may be greater than the first threshold). In other words, if the difference is small, then the scheduling controller may increase the sleep period so that the estimator performs computations less frequently, and if the difference is large, then the scheduling controller may decrease the sleep period so that the estimator performs computations more frequently. The scheduling controller may maintain the sleep period at a current duration if the difference between the feedback data and the reference data is between the first threshold and the second threshold.

Each time the estimator provides feedback data to the scheduling controller, the scheduling controller may adjust the sleep period in this manner up to a maximum sleep period or down to a minimum sleep period. For example, the scheduling controller may increase the sleep period by the step amount, to at most the maximum sleep period, responsive to the difference between the feedback data and the reference data being less than the first threshold. The scheduling controller may decrease the sleep period by the step amount, to at least the minimum sleep period, responsive to the difference between the feedback data and the reference data being greater than the second threshold. In some implementations, the minimum sleep period, the maximum sleep period, the first threshold, and/or the second threshold may be configured at values to maintain the DCO transceiver in compliance with a standard (e.g., a multi-source agreement (MSA)) with respect to a parameter relating to the physical environment estimations (e.g., the standard may indicate a maximum carrier frequency offset that is permitted, among other examples).

In some implementations, the scheduling controller may sweep through different sleep period durations to identify an optimal sleep period. For example, starting from the minimum sleep period and up to the maximum sleep period, the scheduling controller may increment the sleep period each time the estimator provides feedback data to the scheduling controller. Continuing with the example, at each increment, the scheduling controller may determine whether the sleep period provides an optimal result (e.g., the difference between the feedback data and the reference data is a minimal value). After sweeping through each increment, the scheduling controller may set the sleep period at the optimal sleep period.

In some implementations, the scheduling controller may adjust the sleep period using a moving average-based control approach. Here, the comparison of the feedback data and the reference data may include a comparison of a moving average, based on the feedback data (e.g., an average of the feedback data and an N previous feedback data, N≥1), and the reference data. Moreover, adjusting the sleep period may include increasing the sleep period based on the comparison of the moving average and the reference data indicating an improvement of a quality of the signal, or decreasing the sleep period based on the comparison of the moving average and the reference data indicating a deterioration of the quality of the signal, in a similar manner as described above. For example, the sleep period may be adjusted by step amounts, in a similar manner as described above.

In some implementations, the scheduling controller may adjust the sleep period using a proportional-integral-derivative (PID) controller approach. Here, the comparison of the feedback data and the reference data may include computing PID feedback based on a difference between the feedback data (e.g., the physical environment estimation) and the reference data (e.g., a setpoint). Moreover, adjusting of the sleep period may include adjusting the sleep period using a PID control actuating on the sleep period based on the PID feedback. For example, the scheduling controller may adjust the sleep period based on an actuating signal that is based on the PID feedback. Other control approaches may also be suitable for use by the scheduling controller to adjust the sleep waiting period.

In this way, the scheduling controller may schedule execution of the estimator in accordance with the adjusted sleep period. For example, the scheduling controller may cause the estimator to enter a sleep mode for the sleep period. The scheduling controller may wait for the sleep period before causing a subsequent execution of the estimator (e.g., by providing a control signal to the estimator, as described herein). Moreover, the scheduling controller may obtain feedback data from the estimator relating to the subsequent execution, which the scheduling controller may use for further adjustment of the sleep period, and so forth each time the estimator executes. Accordingly, the scheduling controller provides dynamic duty cycle control for the estimator. For example, the estimator may include periodic-execution hardware, as described herein, and adjustment of the sleep period may dynamically change a duty cycle of the periodic-execution hardware. In this way, the scheduling controller may reduce power consumption by the estimator while ensuring frequent-enough execution of the estimator to facilitate signal correction and recovery by the corrector.

As indicated above, FIG. 2 is provided as an example. Other examples may differ from what is described with regard to FIG. 2.

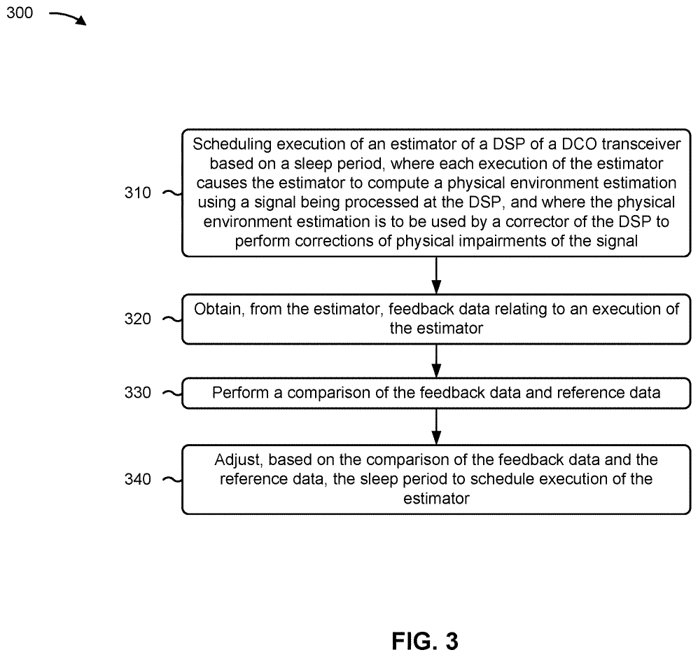

FIG. 3 is a flowchart of an example process 300 associated with dynamic duty cycle control for an estimator. In some implementations, one or more process blocks of FIG. 3 are performed by a controller (e.g., scheduling controller 128). In some implementations, one or more process blocks of FIG. 3 are performed by another device or a group of devices separate from or including the controller, such as a DSP (e.g., DSP 102), a corrector (e.g., corrector 124), an estimator (e.g., estimator 126), or a processor of a DCO transceiver (e.g., DCO transceiver 100). Additionally, or alternatively, one or more process blocks of FIG. 3 may be performed by one or more components of DCO transceiver 100.

As shown in FIG. 3, process 300 may include scheduling execution of an estimator of a DSP of a DCO transceiver based on a sleep period, where each execution of the estimator causes the estimator to compute a physical environment estimation using a signal being processed at the DSP or other information about the DCO transceiver and/or its components, and where the physical environment estimation is to be used by a corrector of the DSP to perform corrections of physical impairments of the signal (block 310). For example, the controller may schedule execution of an estimator of a DSP of a DCO transceiver based on a sleep period, as described above. In some implementations, each execution of the estimator causes the estimator to compute a physical environment estimation using a signal being processed at the DSP or other information about the DCO transceiver and/or its components. In some implementations, the physical environment estimation is to be used by a corrector of the DSP to perform corrections of physical impairments of the signal.

As further shown in FIG. 3, process 300 may include obtaining, from the estimator, feedback data relating to an execution of the estimator (block 320). For example, the controller may obtain, from the estimator, feedback data relating to an execution of the estimator, as described above.

As further shown in FIG. 3, process 300 may include performing a comparison of the feedback data and reference data (block 330). For example, the controller may perform a comparison of the feedback data and reference data, as described above.

As further shown in FIG. 3, process 300 may include adjusting, based on the comparison of the feedback data and the reference data, the sleep period to schedule execution of the estimator (block 340). For example, the controller may adjust, based on the comparison of the feedback data and the reference data, the sleep period to schedule execution of the estimator, as described above.

Process 300 may include additional implementations, such as any single implementation or any combination of implementations described below and/or in connection with one or more other processes described elsewhere herein.

In a first implementation, the reference data is previous feedback data relating to a previous execution of the estimator, and performing the comparison of the feedback data and the reference data includes determining a difference between the feedback data and the previous feedback data.

In a second implementation, alone or in combination with the first implementation, process 300 includes storing the previous feedback data in a storage location, and retrieving the previous feedback data from the storage location to perform the comparison of the feedback data and the reference data.

In a third implementation, alone or in combination with one or more of the first and second implementations, adjusting the sleep period includes adjusting the sleep period by a step amount based on the difference between the feedback data and the previous feedback data, where the sleep period is to be increased by the step amount responsive to the difference being less than a first threshold, or decreased by the step amount responsive to the difference being greater than a second threshold, wherein the second threshold is greater than the first threshold.

In a fourth implementation, alone or in combination with one or more of the first through third implementations, the sleep period is to be increased by the step amount, to at most a maximum sleep period, responsive to the difference being less than the first threshold, or decreased by the step amount, to at least a minimum sleep period, responsive to the difference being greater than the second threshold.

In a fifth implementation, alone or in combination with one or more of the first through fourth implementations, at least one of the minimum sleep period, the maximum sleep period, the first threshold, or the second threshold is configured to maintain the DCO transceiver in compliance with a standard with respect to a parameter relating to the physical environment estimations.

Although FIG. 3 shows example blocks of process 300, in some implementations, process 300 includes additional blocks, fewer blocks, different blocks, or differently arranged blocks than those depicted in FIG. 3. Additionally, or alternatively, two or more of the blocks of process 300 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be designed to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A digital coherent optics (DCO) transceiver, comprising:
an optical receiver, comprising:
reception optics configured to receive an optical reception signal; and
a demodulator configured to recover an electrical reception signal from the optical reception signal using a local oscillator signal;
an optical transmitter, comprising:
a modulator configured to produce an optical transmission signal by modulating an optical carrier signal from a laser source with an electrical transmission signal; and
transmission optics configured to transmit the optical transmission signal;
a digital signal processor (DSP) that includes an estimator configured to compute physical environment estimations using a digital signal that is based on the electrical reception signal or the electrical transmission signal, and a corrector configured to perform corrections of physical impairments of the digital signal based on the physical environment estimations; and
a controller configured to:
schedule execution of the estimator based on a sleep period,
wherein each execution of the estimator causes the estimator to compute a physical environment estimation using the digital signal;
obtain, from the estimator, feedback data relating to the physical environment estimation; and
adjust, based on the feedback data, the sleep period to schedule execution of the estimator.

2. The DCO transceiver of claim 1, wherein the estimator is a carrier frequency offset estimator, a carrier phase offset estimator, a clock phase error estimator, a DC offset estimator, an in-phase and quadrature (IQ) imbalance coefficients estimator, or a non-linear effects estimator.

3. The DCO transceiver of claim 1, wherein the physical environment estimations relate to carrier frequency, carrier phase, clock phase, DC offset, in-phase and quadrature (IQ) imbalance, or optical fiber impairments.

4. The DCO transceiver of claim 1, wherein the controller, to adjust the sleep period, is configured to:
increase the sleep period based on a comparison of the feedback data and reference data indicating an improvement of a quality of the digital signal, or decrease the sleep period based on the comparison of the feedback data and the reference data indicating a deterioration of the quality of the digital signal.

5. The DCO transceiver of claim 1, wherein the controller is further configured to:
compute proportional-integral-derivative (PID) feedback based on a difference between the feedback data and reference data, and
wherein the controller, to adjust the sleep period, is configured to:
adjust the sleep period using a PID control actuating on the sleep period based on the PID feedback.

6. The DCO transceiver of claim 1, wherein the controller is further configured to:
perform a comparison of a moving average, based on the feedback data, and reference data, and
wherein the controller, to adjust the sleep period, is configured to:
increase the sleep period based on the comparison of the moving average and the reference data indicating an improvement of a quality of the digital signal, or decrease the sleep period based on the comparison of the moving average and the reference data indicating a deterioration of the quality of the digital signal.

7. The DCO transceiver of claim 1, wherein the corrector is configured to:
receive an output of the estimator;
apply a tuning to the corrector based on the output; and
process the digital signal based on the tuning that is applied.

8. The DCO transceiver of claim 1, wherein the controller is firmware or hardware.

9. A method, comprising:
scheduling, by a controller of a digital coherent optics (DCO) transceiver, execution of an estimator of a digital signal processor (DSP) of the DCO transceiver based on a sleep period,
wherein each execution of the estimator causes the estimator to compute a physical environment estimation using a signal being processed at the DSP, and
wherein the physical environment estimation is to be used by a corrector of the DSP to perform corrections of physical impairments of the signal;
obtaining, by the controller and from the estimator, feedback data relating to an execution of the estimator;
performing, by the controller, a comparison of the feedback data and reference data; and
adjusting, by the controller and based on the comparison of the feedback data and the reference data, the sleep period to schedule execution of the estimator.

10. The method of claim 9, wherein the reference data is previous feedback data relating to a previous execution of the estimator, and
wherein performing the comparison of the feedback data and the reference data comprises:
determining a difference between the feedback data and the previous feedback data.

11. The method of claim 10, further comprising:
storing the previous feedback data in a storage location; and
retrieving the previous feedback data from the storage location to perform the comparison of the feedback data and the reference data.

12. The method of claim 10, wherein adjusting the sleep period comprises:
adjusting the sleep period by a step amount based on the difference between the feedback data and the previous feedback data, and
wherein the sleep period is to be increased by the step amount responsive to the difference being less than a first threshold, or decreased by the step amount responsive to the difference being greater than a second threshold,
wherein the second threshold is greater than the first threshold.

13. The method of claim 12, wherein the sleep period is to be increased by the step amount, to at most a maximum sleep period, responsive to the difference being less than the first threshold, or decreased by the step amount, to at least a minimum sleep period, responsive to the difference being greater than the second threshold.

14. The method of claim 13, wherein at least one of the minimum sleep period, the maximum sleep period, the first threshold, or the second threshold is configured to maintain the DCO transceiver in compliance with a standard with respect to a parameter relating to the physical environment estimations.

15. A digital coherent optics (DCO) transceiver, comprising:
a digital signal processor (DSP) that includes an estimator configured to compute physical environment estimations using a signal at the DSP, and a corrector configured to perform corrections of physical impairments of the signal based on the physical environment estimations; and
a controller configured to:
schedule execution of the estimator based on a sleep period,
wherein each execution of the estimator causes the estimator to compute a physical environment estimation using the signal;
obtain, from the estimator, feedback data relating to an execution of the estimator; and
adjust, based on the feedback data, the sleep period to schedule execution of the estimator.

16. The DCO transceiver of claim 15, wherein the controller, to adjust the sleep period, is configured to:
increase the sleep period based on a comparison of the feedback data and reference data indicating an improvement of a quality of the digital signal, or decrease the sleep period based on the comparison of the feedback data and the reference data indicating a deterioration of the quality of the digital signal.

17. The DCO transceiver of claim 15, wherein the DSP includes the controller.

18. The DCO transceiver of claim 15, wherein the estimator includes periodic-execution hardware, and
wherein adjustment of the sleep period is to dynamically change a duty cycle of the periodic-execution hardware.

19. The DCO transceiver of claim 18, wherein a configuration of the periodic-execution hardware is unmodified from a fixed-duty-cycle configuration of the periodic-execution hardware.

20. The DCO transceiver of claim 15, wherein the controller is further configured to:
cause the estimator to enter a sleep mode for the sleep period.
